(19) United States
(12) Patent Application Publication
(10) Pub. No.: US 2023/0385958 A1
(43) Pub. Date: Nov. 30, 2023

(54) SYSTEMS AND METHODS FOR USE IN IDENTIFYING TRIALS IN FIELDS

(71) Applicant: CLIMATE LLC, Saint Louis, MO (US)

(72) Inventors: Venkata GHANTA, Chesterfield, MO (US); Jacob MCDANIEL, O'Fallon, MO (US); Nicholas P. OCHS, Ellisville, MO (US); Daljit SINGH, Erie, CO (US)

(21) Appl. No.: 18/201,728

(22) Filed: May 24, 2023

Related U.S. Application Data
(60) Provisional application No. 63/346,124, filed on May 26, 2022.

(51) Int. Cl. G06Q 50/02; G06Q 10/0637

(52) U.S. Cl. CPC G06Q 50/02; G06Q 10/0637

(57) ABSTRACT

Systems and methods for use in identifying a trial in a target field are provided. One example computer-implemented method includes accessing, for a target field, planting data for the target field from a data structure and identifying one or multiple segment(s) of the target field having a feature distinct from a remainder of the field. The method also includes applying a first geometric threshold to the identified segment(s) and, in response to the identified segment(s) satisfying the first geometric threshold: validating a strip including the segment(s), based on a length and width of the strip, and building a trial based on the strip, wherein the trial includes the strip and at least one duplicate strip disposed along a long side of the strip, where the trial is identified as a location of the trial in the target field.

### CROSS-REFERENCE TO RELATED APPLICATION

This application claims the benefit of, and priority to, U.S. Provisional Application No. 63/346,124 filed on May 26, 2022. The entire disclosure of the above-referenced application is incorporated herein by reference.

### FIELD

The present disclosure generally relates to systems and methods for use in detecting, identifying, etc. trials in fields (e.g., locations of trials within fields, locations for implementing trials in fields, etc.) (e.g., agricultural trials, etc.) and, more particularly, to detecting trials in fields based on data associated with the fields, such as, for example, planting data, treatment data, etc. relating to crops planted in the fields, etc.

### BACKGROUND

This section provides background information related to the present disclosure which is not necessarily prior art.

It is known for seeds to be grown in fields, by growers, for various purposes, including agronomic purposes, whereby resulting plants, or parts thereof, are sold by the growers for business purposes and/or profit. Often, the growers may experiment with different variables (e.g., planting rates, varieties, planting timing, etc.) as part of growing the seeds, for example, from seed selection to field treatments, in relatively small parts of the growers' fields. Results from such experiments may then be used to support changes to the selected seeds and/or the treatments of the fields, and associated ones of the variables used in and/or on the fields, in future planting/growing plans.

### SUMMARY

This section provides a general summary of the disclosure, and is not a comprehensive disclosure of its full scope or all of its features.

Example embodiments of the present disclosure generally relate to computer-implemented methods for use in detecting, identifying, etc. trials in fields. In one example embodiment, such a method for identifying a trial in a target field generally includes accessing, by a computing device, for a target field, planting data for the target field from a data structure; identifying, by the computing device, one or multiple segment(s) of the target field having at least one feature distinct from a remainder of the field; applying, by the computing device, a first geometric threshold to the identified segment(s); and in response to the identified segment(s) satisfying the first geometric threshold: (i) validating, by the computing device, at least one strip including the segment(s), based on a length and width of the at least one strip; and (ii) building, by the computing device, a trial based on the at least one strip, wherein the trial includes the at least one strip and at least one duplicate strip disposed along a long side of the at least one strip, the trial identified as a location of the trial in the target field.

Example embodiments of the present disclosure also generally relate to systems for use in detecting, identifying, etc. trials in fields. In one example embodiment, such a system for identifying a trial in a target field generally includes an agricultural computer system, which is configured, by executable instructions, to: access, for a target field, planting data for the target field from a data structure; identify one or multiple segment(s) of the target field having at least one feature distinct from a remainder of the field; apply a first geometric threshold to the identified segment(s); and in response to the identified segment(s) satisfying the first geometric threshold: (i) simplify a geometry of each of the segment(s); (ii) group the segment(s) into a strip; (iii) validate the strip based on a second geometric threshold; and (iv) in response to the strip being validated, build a trial based on the strip, wherein the trial includes the strip and at least one duplicate strip disposed along a long side of the strip, the trial identified as a location of the trial in the target field.

Example embodiments of the present disclosure also generally relate to non-transitory computer-readable storage media comprising executable instructions for detecting, identifying, etc. trials in fields, which when executed by at least one processor, cause the at least one processor to perform one or more of the operations recited in the above example method(s) and/or system(s).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example embodiment of a system for identifying trials in fields (e.g., in target fields, etc.);

FIG. 2 illustrates an example target field that may be included in the system of FIG. 1, in which an example trial, having three segments, is disposed;

FIGS. 3A-3C illustrate example planted, untreated segments of a field, and bounding boxes applied to the segments, generated consistent with the configuration of the example system of FIG. 1 as part of detecting and/or identifying a trial (or trials) in the field;

FIG. 4 illustrates a chart of example discretized, continuous data for a planting rate of seeds in a field, separated into different ranges consistent with the system of FIG. 1, in connection with detecting and/or identifying a trial (or trials) in the field;

FIG. 5 illustrates an example mapping of segments into a field arrangement, for example, based on the chart of FIG. 4;

FIG. 6 illustrates an example method of identifying a trial in a field, based on data indicative of the field, where the method may be employed in connection with the system of FIG. 1;

FIG. 7 depicts an example embodiment of a timeline view for data entry that may be generated and/or displayed in connection with the system of FIG. 1 and/or the method of FIG. 6;

FIG. 8 depicts an example spreadsheet view for data entry that may be generated and/or displayed in connection with the system of FIG. 1 and/or the method of FIG. 6;

FIGS. 9A-9B illustrate example logical organization of sets of instructions in main memory of a computing device when an example application is loaded for execution;

FIG. 10 illustrates a programmed process by which the system of FIG. 1 and/or the method of FIG. 6 generates one or more preconfigured agronomic model(s) using agronomic data provided by one or more data source(s); and

FIG. 11 is a block diagram that illustrates an example computer system upon which embodiments of the system of FIG. 1 and/or the method of FIG. 6 may be implemented.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Experiments and/or trials may be used by growers to provide support for changes in seeds selected for planting in fields, for changes in treatments applied to fields and/or crops included in the fields, or for changes in various parameters associated with the crops or with the fields or with the planting and/or harvesting of the crops in the fields, etc. In connection therewith, the experiments and/or trials may be defined in triplet (or as a triplet), where three strips are provided to account for variations in the field (e.g., two test strips and one control strip; one test strip and two control strips, etc.), or the experiments and/or trials may be defined in other formats of strips (e.g., in two strips, in more than three strips, in other arrangements of test strips and control strips, etc.), or the experiments and/or trials may be defined in spatial configurations other than strips (whereby a particular shape of the experiments and/or trials is not required, etc.), etc. When growers implement the experiments and/or trials, the experiments and/or trials may not be particularly identified for the fields, or may not be sufficiently identified to a specific location in the fields. As such, data from the experiments and/or trials may be combined and/or contaminated with other data from the fields, whereby results may be inaccurate, inconclusive, etc.

Uniquely, the systems and methods herein provide for detecting and/or identifying and/or locating trials (and/or experiments) in fields, based on data associated with the fields (e.g., the fields themselves, crops in the fields, etc.). In this manner, the trials may be readily detected and/or identified and/or distinguished in the fields (e.g., locations of the trials in the fields may be identified, etc.), and the associated data for the trials may then be isolated from data for other parts of the fields and compared to provide accurate indications of results of the trials. Additionally, or alternatively, the systems and methods herein may further provide for assessment of the data from the trials, for example, in connection with identifying, recommending, etc. changes to certain parameters of the fields based on outcomes of the trials (e.g., seeds planted, growing conditions, harvest processes, etc.). In this manner, the systems and methods herein provide for automated identification of trials in the fields, based on the specific data (e.g., sensor data, etc.) described herein. As such, there is no reliance, or potentially limited reliance, on manual entry of data indicative of the location and/or presence of the trials in the fields, which, based on the manual action, may be inaccurate or incomplete (e.g., where there is no intent to report the trials, or where precise locations are not feasible after-the-fact, etc.), etc.

More generally, the systems and methods herein rely on specific data indicative of fields (e.g., received via sensors, etc.) to automatedly, accurately, and objectively identify trials in the fields in the absence of specific user-defined or user-provided locations of the trials in the fields.

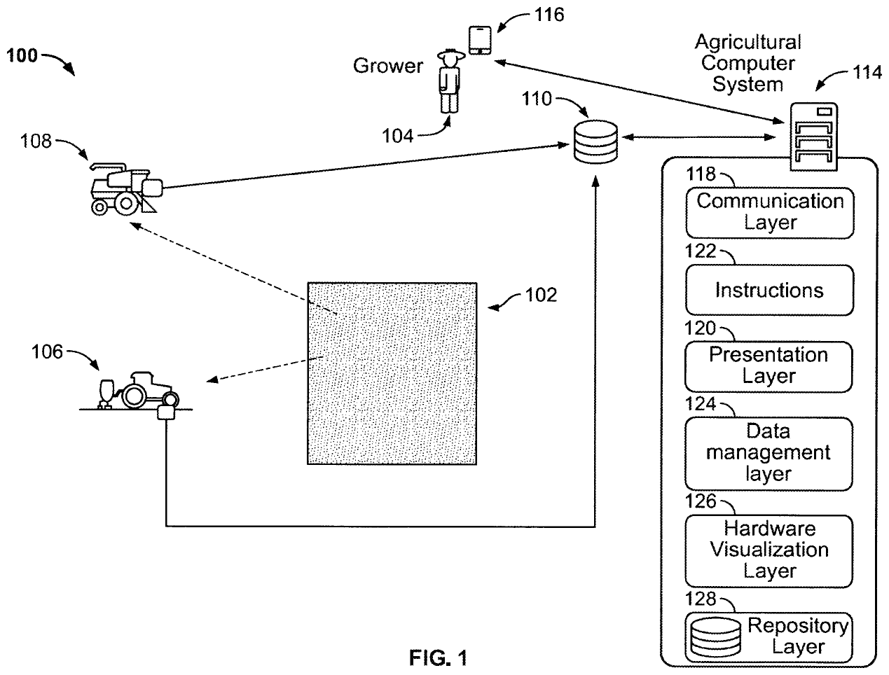

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, relationships between users (e.g., growers, etc.) in the system 100, farm equipment used in the system 100 and numbers and/or arrangements of fields, data flows, types of plants included in fields, types and/or locations of fields, numbers and/or types of trials included in fields, planting and/or harvest activities in the fields, privacy and/or data requirements, etc.

As shown in the embodiment of FIG. 1, the system 100 generally includes a field 102 (broadly, a growing space) in which seeds/plants are planted, grown and harvested (e.g., by grower 104, etc.). It should be appreciated that the field 102 is provided for illustration, and that systems consistent with the present disclosure often includes dozens, hundreds or thousands of fields, or more or less, etc., each of which may be subject to the description herein. In general, in this example, the field 102 is owned and/or worked by the grower 104 (and/or by an entity associated with the grower, etc.), who is in the business of planting, growing, and harvesting crops, over a period of various seasons.

In connection therewith, the grower 104 provides for certain farm equipment to be used for planting, growing, treating, and harvesting a crop (or multiple crops), etc. in the field 102. In this example embodiment, the system 100 includes a planter 106 and a harvester 108. The planter 106, for example, is configured to dispense seeds into the field 102 in a particular manner (e.g., in a particular pattern such as in lines, at a particular rate, etc.) over a swath of the planter 106, whereby multiple rows are planted at one time. And, the harvester 108 may include, for example, a combine, a picker, or other mechanism for harvesting plants/crops from the field 102. The harvester 108 may be automated, or reliant, at least in part, on a human operator, etc. The harvester 108, in general, is configured to remove a part of a plant grown from the planted seeds (e.g., an ear of corn, beans from soybeans, grain from wheat, etc.), which is referred to herein as harvesting. The harvester 108 may additionally, or alternatively, perform operations including picking, threshing, cutting, reaping, gathering, etc.

It should be appreciated that other farm equipment may be used in the field 102 (and more generally, in the system 100), including, for example, a sprayer (not shown), which is configured to apply one or more treatments (e.g., chemical treatments, biological treatments, etc.) to the crop(s) in the field 102, prior to planting, after planting and/or prior to harvest of the crop(s). Still other equipment may be employed in the field 102 and configured to perform operations related to the planting, growing, irrigating, or harvesting of the crop(s) therein within the scope of the present disclosure.

As part of the above, the farm equipment (e.g., the planter 106, the harvester 108, etc.) is configured to collect data and to transmit the data to data server 110. For example, the planter 106 is configured to implement a planting plan for the field 102 and also to compile data specific to at least planting and/or execution of the planting plan. The data (e.g., planting data, etc.) may include, without limitation, seed type/name, seed/row position, location data, planting rate, planting direction, headland location(s), date/time data, or other suitable data, etc. The planter 106 is configured to determine, compile/collect and/or transmit the planting data to the data server 110. Similarly, the harvester 108 is configured to compile/collect data specific to the plant(s) being harvested and to the operation of harvesting of the plant(s), etc. The data (e.g., harvesting data, etc.) may include, without limitation, location of the field 102 and/or plants (e.g., as expressed in latitude/longitude or otherwise, etc.), yield, weight, moisture content, volume, flow, headland location(s), date/time data, or other suitable data, etc. associated with the harvested crop(s) and/or harvesting operation in the field 102. The harvester 108 is configured to transmit the gathered data to the data server 110.

It should be appreciated that further farm equipment may be included in the field 102, that may also be configured to compile/collect and transmit data to the data server 110. It should be further appreciated that data about the field 102 and/or crop in the field may be compiled and/or collected, and also transmitted to the data server 110, in whole or in part, independent of the farm equipment. For example, certain data related to the field 102, such as, for example, the planting plan, field description or definition (e.g., boundary, soil types, etc.), headland location(s), temperatures, moisture, geology, etc., may also be compiled and/or collected, or may be defined by the grower 104, and transmitted to the data server 110. Moreover, in some example embodiments, data related to the field 102 may be obtained through sensors in and/or around the field 102 (e.g., remote sensors, etc.) and transmitted by the sensors to the data server 110 (e.g., precipitation/moisture data, etc.).

As noted above, in various embodiments, the data collected by the farm equipment (e.g., the planter 106, the harvester 108, etc.) and/or data collected otherwise, and included in the data server 110, may include, for example, boundary data (or boundary line data) for the field 102 (and/or other fields), headland data for the field (and/or for other fields), and direction data of the crop(s) in the field 102. In addition, headland data for the field 102 (and/or for other fields) may be included in the data server 110, for example, as generated based on such data collected by the farm equipment, etc.

In particular, for example, the field 102 is defined by a boundary, which traces an outside perimeter of the field 102, and serves to distinguish the field 102 from other fields or other areas, and specifically, neighboring fields, forests, other property, etc. The boundary may be defined by a legal border, structures (e.g., roads, railroad tracks, etc.), water ways (e.g., rivers, ditches, canals, etc.), or otherwise, etc. It should be appreciated that in some examples the boundary of the field 102, for example, may be defined by the grower 104 to separate contiguous land owned/operated by the grower 104 into more than one field (e.g., the field 102 and another field, etc.). Consistent with the above, in this example, the boundary for the field 102 is defined by coordinates (e.g., as defined by the grower 104 and/or captured by farm equipment, etc.), which are stored in the data server 110.

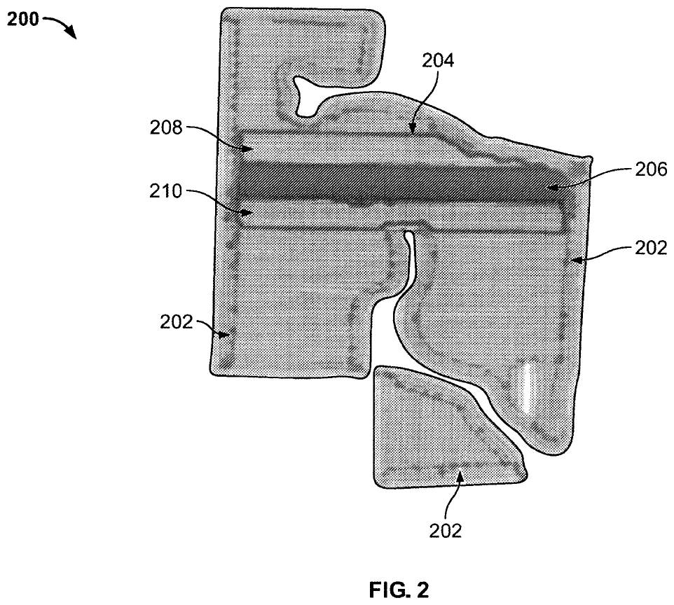

FIG. 2 illustrates an example field 200, which is defined by a boundary. In connection with the boundary, the field 200, which is a target field in this example, also includes parts, areas, regions, portions, etc. which are designated as headlands 202. The headlands 202 are generally a strip or segment or section/portion of land in the field 200 that may be unplanted and/or inaccessible, for example, due to a turn radius of farm equipment in the field 200 (e.g., the planter 106, etc.), or an obstacle in the field 200 (e.g., standing water, utilities, trees, rocks, etc.), or that may be planted with seed but that may have operational abnormalities that could hinder the plants ability to perform. As such, the headlands 202 may include, for example, areas that are driven over during planted, areas used to turn farm equipment around in the field 200, areas that are driven around due to obstacles, or other areas thereby resulting in such operational abnormalities, etc. The headlands 204 may be designated, measured and/or determined based on data received by and/or from farm equipment used in the field 102 to plant, harvest or otherwise interact with the field 200 (e.g., the planter 106, the harvester 108, etc. as shown in FIG. 1, or otherwise; etc.).

Additionally, or alternatively, the headlands 202 may be estimated, for example, as a threshold distance from a boundary line and/or missing data for the field 200. For example, the headlands 202 may be defined as a two swath width of farm equipment (e.g., of the planter 106 shown in FIG. 1 (e.g., 60 feet, or more or less, etc.), etc.) from the boundary line of the field 200. Similarly, for example, an obstacle in the field 102, such as a rock, a tree, etc., may prevent planting in that part of the field 200 by the planter 106, whereby planting data for that part of the field 200 is absent. As such, the absence of data for a part of the field 200, for example, may be understood as an obstacle in the field 200 (or a headland 202, more generally), whereby the two swath width may again be applied to define the headland 202 associated with the obstacle. It should be appreciated that headlands within the center of a field, or apart from the boundary line, may be considered, or omitted, in various embodiment herein. Regardless, as shown in FIG. 2, the headlands 202 include the area around the perimeter of the two segments or portions of the field 200. Data indicative of the headlands 202 is stored for the field 200 in the data server 110.

Also shown in FIG. 2, a trial 204 is included in the field 200, where the trial 204 includes a triplet of strips, in this example. It should be appreciated that trials may have configurations and/or shapes other than strips in other embodiments. In this example, though, where the trial 204 includes the triplet of strips, the center strip 206 is the control strip for the trial 204, and the remaining strips 208, 210 are the test strips for the trial 204.

Referring again to FIG. 1, the data server 110 is configured to store the data received from the farm equipment, or otherwise, in one or more data structures (e.g., tables, lists, records, arrays, matrices, etc.). The data may include, without limitation, planting data (e.g., planting plan, seeds, rates, locations, etc.), harvest data, treatment data, headland data (e.g., locations, etc.), field definitions/boundaries, date/time data, etc.

That said, in general in the system 100, the grower 104 may desire to enhance performance of the crop(s) planted in the field 102. A higher yield, for example, may provide a greater commercial benefit of the field 102. As such, from time to time, the grower 104 may decide to alter one or more conditions of the field 102, for example, as to the type/variety of seeds planted or as to the growing conditions as the seeds grown into plants (e.g., through treatments, irrigation, etc.), and then as to harvesting the crops (e.g., moisture content at harvest, etc.) to determine the success of the alteration(s). Implementing such alteration(s) is generally referred to herein as a trial (or trials or experiment or experiments). In connection therewith, the trial may be defined to include one or more treatments or combination of treatments (e.g., fertilizer, herbicide, insecticide, etc.), one or more different types of seeds (e.g., types, varieties, etc.), one or more different irrigation settings and/or schedules, one or more different harvesting schedules, etc. Further, the trial may be specified by the grower 104, or may be designed by a provider of the seeds and/or the treatment(s), or a combination of both, etc.

In connection with the planting by the planter 106, for example, or treatment by farm equipment (e.g., by an aerial sprayer, ground sprayer, etc.), the trial is implemented in the field 102, by the grower 104. Despite the data included in the data server 110, the specific location of the trial in the field 102, for example, may be omitted or unclear, whereby data specific to the trial (e.g., location and/or number of test strip(s), control strip(s), etc.) is not identifiable to the trial. In this example embodiment, the system 100 includes an agricultural computer system 114, which is programmed, or configured, to detect, locate, identify, etc. the trial in the field 102 based on the data included in the data server 110, etc.

In particular, the agricultural computer system 114 may be configured in one or more manners as generally described herein, depending, for example, on the type of data available for the field 102 and/or the test variable(s) included in the trial (e.g., seed rate variance, treatment/no treatment, etc.). In general, in this embodiment, the agricultural computer system 114 is configured to detect certain strips (broadly, locations) in the field 102, and then to build the trial from the detected strips. For example, the agricultural computer system 114 may be configured to detect control strips, from the data, and then to build the trial triplets, for example, from the control strips (e.g., either one control strip or multiple control strips, etc.). It should be appreciated that the control strip may be duplicated (i.e., in size and shape) to form the other one or more strips of the triplet. It should be appreciated that, alternatively, the agricultural computer system 114 may be configured to detect test strip(s), and then build the trial with one or more control strip(s), etc.

Various implementations are described below, in which the agricultural computer system 114 is configured to detect the trial in the field 102 based on data associated with the field 102.

In one example implementation in the system 100 (of detecting and/or identifying a trial in the field 102), the data indicative of the field 102 is discrete, as to a treatment of the field (e.g., a chemical treatment, a biological treatment, etc.), for example, whereby the discrete data is stored in the data server 110. And, based on the discrete data, the agricultural computer system 114 is configured, in this example, to identify the untreated segments of the field 102 by overlaying the planting data and the treatment data for the field 102, from the data server 110, on the field 102. Specifically, the data is indicative of locations in the field 102, for example, by cells or coordinates, whereby a cell is identified as either not planted, planted and not treated, or planted and treated. In doing so, the locations (or cells) may have sizes of about 1 meter by about 1 meter, about 3 meters by about 3 meters, about 5 meters by about 5 meters, about 2 meters by about 5 meters, other larger or smaller sizes, other shapes and/or configurations (e.g., other than square, other than rectangular, etc.) (e.g., circular, triangular, polygonal, otherwise, etc.), etc. Further, it should be appreciated that the locations (or cells) may each be similar in size, or one or more of the locations may be different in size from other ones of the locations. In identifying the untreated segments (or cells) of the field 102, the agricultural computer system 114 is configured to retain the planted and untreated segments (or cells).

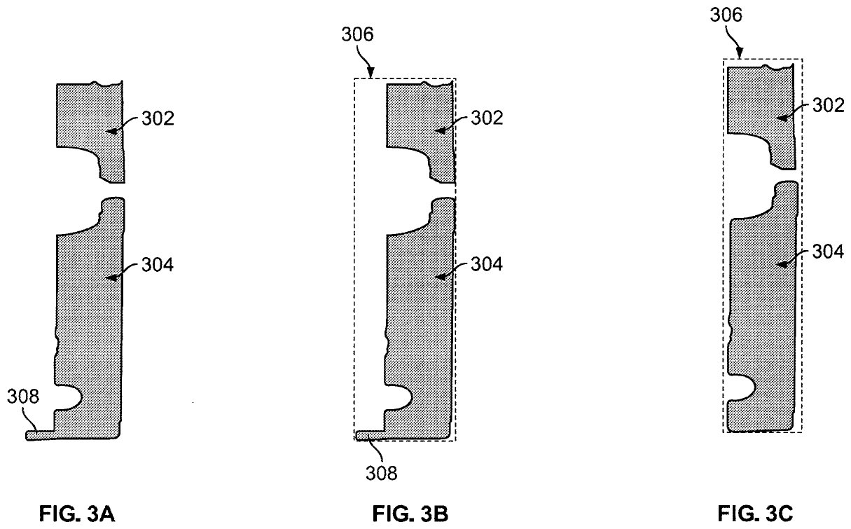

In addition, the agricultural computer system 114 may be configured to further rely on the headlands for the field 102 in identifying the unplanted and untreated segments, by filtering out or subtracting segments within the headlands. In connection therewith, FIG. 3A illustrates planted and untreated segments 302, 304 (or cells, etc.) for an example field (e.g., for a candidate strip or control area in the field, etc.) (e.g., for example field 200, etc.), where the treated segments and heathlands are omitted or removed from view.

Next, the agricultural computer system 114 is configured to filter the planted and untreated segments based on the geometry of the planted and untreated segments (e.g., within the field 102, within the candidate strip(s) or control area(s) in the field 102, etc.). Specifically, for example, the agricultural computer system 114 is configured to impose a minimum width for the planted and untreated segments. As the agricultural computer system 114 is configured to identify a trial, and in particular, in this example, a candidate strip (or segment or control area) included in a trial, it is apparent that a trial would have some limited, minimum width, for example, when being defined. Here, for example, the agricultural computer system 114 is configured to impose a minimum width of about 15, about 20, about 30 or about 60 meters, or more or less, etc., to thereby remove or omit segments not meeting the width minimum.

It should be appreciated that other features or geometries of strips or segments of trials, such as, for example, minimum lengths, minimum areas, etc., may be imposed in other system embodiments in connection with omitting segments, etc. For instance, in one example, separate length, area, and width checks (e.g., minimums, etc.) may be employed for each strip or segment. In another example, a bounding box check may be employed for each strip or segment that includes an area-based check. In this example, the agricultural computer system 114 may be configured to generate a minimum rectangular bounding box around a strip or segment (i.e., a minimum area rectangle sufficient to bound the strip or segment). The identified area of the minimum rectangular bounding box, then, may be used as a denominator to divide actual area of the strip/segment to compute a bounding box ratio. The agricultural computer system 114, then, is configured to filter (or remove) the given strip/segment if the ratio is less than a certain geometric threshold (e.g., about 0.5, about 0.6, about 0.7, a threshold larger than about 0.7, a threshold smaller than about 0.6, etc.). In connection with the above, the agricultural computer system 114 may be configured to locate the segments in the field 102 (based on location data associated with the accessed planting data, treatment data, etc.) and group the segments into the strips based on proximity of the segments, etc.

The agricultural computer system 114 is further configured to simplify the geometries of the planted and untreated segments, generally, by smoothing the edges to reduce the location description of the planted and untreated segments. For example, a rectangle includes four points to define the location, i.e., the four corners. The planted and untreated segments 302, 304 in FIG. 3A, by comparison, include many points along their perimeters to accurately describe the geometry and/or location of the planted and untreated segments 302, 304. Therefore, the agricultural computer system 114 may be configured, for example, to apply a simplify function, where the parameter is, for example, one meter, two meters, or more or less, etc., thereby permitting the function to alter the geometry of the planted and untreated segment by that parameter to simplify the geometry (e.g., to approximate a rectangle within a desired threshold, etc.).

The agricultural computer system 114 is next configured to group different planted and untreated segments, if any, into strip groups. As shown in FIG. 3A, for example, the two planted and untreated segments 302, 304, although not contiguous or connected, are likely part of the same control strip, for example. In particular, here, then, the agricultural computer system 114 is configured to determine a centroid of the different planted and untreated segments, and to compare the centroids. As shown in FIG. 3A, given a coordinate system of X and Y, the X components of the centroids of the two planted and untreated segments 302, 304 are likely similar (and likely both lie along a same or similar line extending in a direction generally parallel to the Y-axis of the coordinate system) (e.g., such that crops are planted in the given segments in a direction generally parallel to the Y-axis, etc.). The agricultural computer system 114 is configured to then apply a threshold (e.g., based on the line extending in the direction generally parallel to the Y-axis, etc.), whereby different planted and untreated segments within the threshold are grouped together, and conversely, planted and untreated segments spaced further than the threshold are grouped separately.

In turn, the agricultural computer system 114 is configured to apply a bounding box to the groups of planted and untreated segments. Generally, a bounding box is sufficiently sized to encompass the planted and untreated segments, including, for example, the high and low values of the X and Y coordinates, given the X and Y coordinate system, thereby defining a box enclosing the geometry of the planted and untreated segments. FIG. 3B illustrates a bounding box 306 applied to the planted and untreated segments 302, 304 from FIG. 3A. Next, the agricultural computer system 114 is configured to determine a ratio of area of the planted and untreated segments to the area of the bounding box and to compare the ratio to a threshold. When the threshold is not satisfied, the agricultural computer system 114 is configured to trim or shrink (e.g., by a buffer, etc.) the geometries of the planted and untreated segment by a desired amount (e.g., about 0.5 meters, about one meter, about two meters, or more or less, etc.) and then to repeat the bounding box, ratio and threshold operations. If the ratio still does not satisfy the threshold, the agricultural computer system 114 is configured to further trim or shrink the geometries of the planted and untreated segment again by the desired amount (or other amount), and continue the process until the threshold is satisfied. FIG. 3C illustrates the trimmed, planted and untreated segments 302, 304, and the bounding box 306, where the ratio satisfies, in this example, a ratio of about 50%, about 60%, about 70%, or more or less, etc. Of course, other thresholds may be used in other system embodiments. As shown in FIG. 3B and FIG. 3C, the trimming eliminates the protrusion 308 from the bottom left of the planted and untreated segment 304, thereby making the bounding box 306 more accurate as to the geometry of the planted and untreated segments.

The agricultural computer system 114 is then configured to determine one or more features of the planted and untreated segments, as modified above, and to validate strips defined by the planted and untreated segments. Specifically, for example, a length and width may be determined for the planted and untreated segments (in the group), and then the length and/or width, or an area defined thereby, may be compared to one or more thresholds, etc. In another example, a perimeter of the planted and untreated segments may be determined and compared to a threshold, or an area of the planted and untreated segments (or the bounding box associated therewith) may be compared to one or more thresholds. In this manner, the agricultural computer system 114 is configured to validate the planted and untreated segments as a strip of a trial based on common features typically associated with trials, and/or based on features of the field 102, for example, a common understanding of trials imposed by growers in fields in general, etc.

In view of the above, the agricultural computer system 114 is configured to identify the planted and untreated strip in the field 102.

Next in this implementation of the system 100, the agricultural computer system 114 is configured to build a trial from the strip defined by the planted and untreated segments. Generally, for example, in building the trial, the agricultural computer system 114 is configured to duplicate the strip (having one or more same geometries as the planted and untreated segments (e.g., width, etc.) or the bounding box, yet also defined by the field boundary (e.g., potentially not exact duplicates of the overall shape, area, etc., of the strip, etc.) on either long edge of the strip to define a triplet (i.e., having three strips). In this manner the trial is identified in the field 102 (see, for example, field 200 in FIG. 2 having test strip 206 and control strips 208, 210 located on either long edge of the test strip 206 (yet within the boundary of the field 200), are built or assembled into the trial.

It should be appreciated that in connection with determining the trial, the agricultural computer system 114 may be configured to apply one or more buffers to the edges of the trial, and specifically, the strips, to avoid data indicative of cross contamination therebetween. For example, where a treatment is applied aerially, the treatment may “bleed” into the control strip based on the manner of application. Buffers may therefore be employed, by the agricultural computer system 114, to limit or eliminate the impact of such potential cross contamination on the trial definition, and the data derived therefrom.

Additionally, or alternatively, in this example implementation, the agricultural computer system 114 is configured to determine whether another group of untreated segments is within a threshold distance of the trial. In particular, when a planted and untreated strip is identified as the control strip, it is possible that the control strip is associated with two test strips, one on either side (e.g., as in FIG. 2, etc.). Conversely, it is possible that the control strip is associated with one test strip and then another control strip (i.e., control-test-control), thereby making up a triplet. As such, the agricultural computer system 114 is configured to order the groups of planted and untreated segments (generally referred to as strips) (e.g., by a determined centroid of the groups, etc.) and to determine whether another group of untreated segments, subject to the above, is within a desired distance, for example, about 10 meters, about 15 meters, about 30, meters, about 50 meters, etc., of the planted and untreated strip identified above. If so, the agricultural computer system 114 is then configured to combine the planted and untreated strip with the closest planted and untreated strip and to build the trial, by including a test strip between the two untreated strips (e.g., a planted and treated strip, etc.).

Again, it should be appreciated that the agricultural computer system 114 may be configured to apply one or more buffers to the strips of the trial as described above. However, the agricultural computer system 114 may apply the buffers differently given the treatment, or alteration of the trial (e.g., the control-test-control arrangement, etc.). For example, the buffers may only be applied to the middle test strip, etc.

While the above example starts with the planted and untreated segments of the field 102, for example, as a basis to identify the trials, it should be appreciated that the planted and treated segments of the field 102, and other fields, may likewise be the starting point to identify one or more trials in the field 102, through similar steps to the above, to thereby detect and/or identify the planted and treated segments of the field 102, etc.

In another example implementation of the system 100 (of detecting and/or identifying a trial in the field 102), the data indicative of the field 102 is generally continuous, as to a planting rate, for example, whereby the continuous data is a value in a specific, or unspecific, range, and the data is stored in the data server 110. In this implementation, the agricultural computer system 114 is configured to, initially, separate the continuous data into bands, each having a specific range. For example, where a specific cell or discrete coordinate set of the field 102 is associated with a planting rate value, that planting rate is assigned to a range, and the cell is associated with that range. As shown in chart 400 of FIG. 4, for example, planting rates of different segments (e.g., cells included in given rate bands, etc.) of a field are separated into different ranges, where, in this example, the ranges extend from roughly about 55,000 seeds per hectare to about 72,500 seeds per hectare. It should be appreciated that other desired rates and/or ranges may be utilized within the scope of the present disclosure. Based on the chart 400 shown in FIG. 4, for example, it is apparent that there are generally two main planting rates in the field: one at about 60,000 seeds per hectare, and the other at about 68,000 seeds per hectare (e.g., as generally represented by the peaks 402 in FIG. 4 which include a generally larger number of segments or cells within the given planting rate band, etc.).

Next in this implementation, the agricultural computer system 114 is configured to clean the data, by, for example, removing outliers (e.g., as compared to the peaks, etc.) and rounding off scales. For instance, in removing the outliers, the agricultural computer system 114 may be configured to filter cells or segments having generally extreme values within the given band based on, for example, a desired threshold, etc. (e.g., cells or segments in a top and/or bottom one percent of values within the given band, etc.). And, in rounding, the agricultural computer system 114 may be configured to convert floating points to integers.

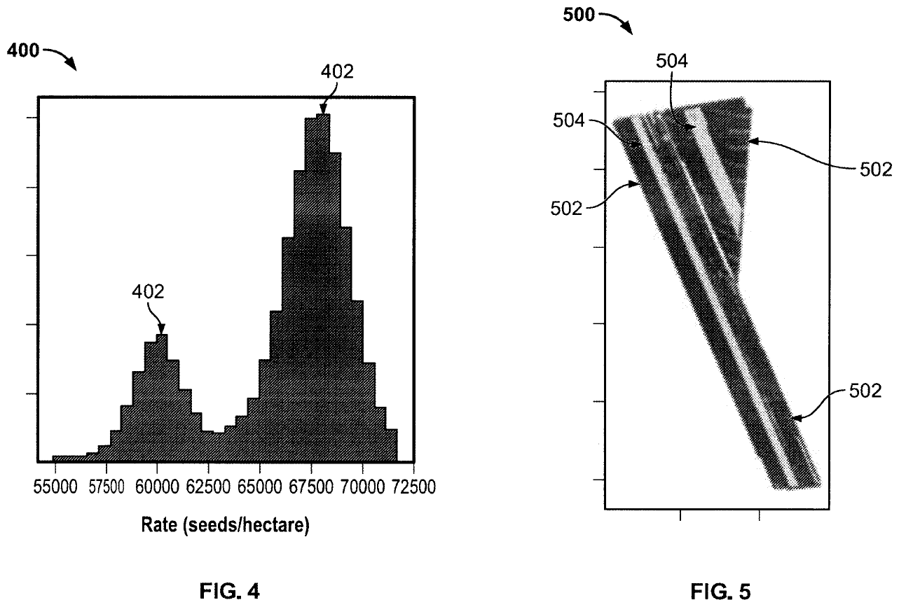

In addition, the agricultural computer system 114 is configured to label the cells or segments of the field 102, based on the bands into which the cells are separated (e.g., via clustering, etc.). For example, as shown in FIG. 4 (in which two peaks are identified), the different segments, as included in the different bands, are subject to two-component clustering, via a Gaussian model, to cluster the segments into the two components (or two labels) based on the planting rate and/or band (broadly, label) into which the segments are separated, etc. In this manner, as shown in FIG. 5, for example, the segments are included in one of the two components, whereby a map 500 of the segments can be provided based thereon (e.g., based on location data for each of the clustered segments in the field, etc.), generally representative of a trial in the given field. As shown, certain ones of the segments form a first geometry 502, while other ones of the segments are clustered into a second geometry 504. It should be appreciated that other clustering and/or classification models and/or techniques may be used to associate the discretized data with a label and then cluster the labels into a map representative of a trial, as illustrated in FIG. 5, for example.

As part of the above, in this implementation, the agricultural computer system 114 is also configured to de-noise the data and/or labels, for example, to smooth out the spatial variability in the labeled/discretized data. In particular, the agricultural computer system 114 may be configured to smooth abrupt changes in cell values (e.g., seed rates, etc.) and/or fill missing cells (or cell values) using a moving average type of filter withing a predominant strip area (e.g., where, in the context of FIG. 5, a grain spec of cells associated with the first geometry are present within the second geometry, and vice-versa; etc.). Such a filter may be is especially beneficial in scenarios where there are missing cells or cell values change abruptly within a predominant strip area (i.e. a grainy speck of group 2 cell happens in the group 1 strip cells).

Next in this example implementation, the agricultural computer system 114 is configured to identify strips in the field 102, based on the labelled data and corresponding map. In particular, for example, as described above, the agricultural computer system 114 may be configured to consider like-labelled segments of the field 102 and to apply filtering based on a width of the labelled segments. The agricultural computer system 114 may further be configured to assign different segments to a group, to impose a bounding box on the group of segments, and to provide buffering of the segments, etc. The agricultural computer system 114, as such, may be configured, in part or in whole, consistent with the prior example implementation (as described with reference to FIGS. 3A-3C) to narrow in on the particular strips of the given trial.

Thereafter, when one or more strips (from the segment groups) are identified in the field 102, the agricultural computer system 114 is configured to validate the strips, for example, based on the length, width, and/or perimeter, and potentially, ratios of the strip(s) to a bounding box for the strip, etc. (as generally described above for the first implementation). To this point, the strip(s) may not be assigned any treatments and may not be classified as control or test/treatment. As such, in the case of seeding rate data, as used in the above implementation, the determination of whether or not a strip is a control or test/treatment may be determined by the grower 104 or other user-defined rate input. Or, the determination may be based on a geometry area of the strip(s), etc.

Next, in this implementation, the agricultural computer system 114 is configured to build the trial from the strip defined by the grouped segments. Generally, for example, the agricultural computer system 114 is configured to duplicate the strip (having the same geometry as the grouped segments, while within the boundary/headlands of the field 102) on either long edge of the strip to define a triplet (e.g., a test-control-test triplet, a control-test-control, etc.). In this manner the trial is identified in the field.

It should be appreciated that the above implementations may be employed, in whole or in part, together or separately, whereby the agricultural computer system 114 is configured to identify one or more trials in one or more fields, etc.

Further to the above, the agricultural computer system 114 may also be configured to assess and/or evaluate the identified trial, or more generally, any planting space including the trial (e.g., the field 102, etc.), in which two geometries of plantings/crops differ (e.g., as in the trial, etc.). Specifically, for example, when testing a difference, such as, for example, a difference in planting rate (e.g., as in FIG. 5, etc.), a difference in hybrids, a difference in treatment (e.g., as in FIG. 2, etc.), etc., or other difference, the agricultural computer system 114 may be configured to generate one or more metrics (e.g., one or more assessment metrics, etc.) relating to the difference (e.g., a fitness metric as generally described in Applicant's US patent application entitled “Systems and Methods for use in Assessing Trials in Fields”, etc., which is incorporated herein by reference). In connection therewith, the metric(s) may be configured to quantify similarities of two regions in the field 102 where a target condition is different between the regions (e.g., one region including a treated crop and the other region including an untreated crop, etc.), etc. In this manner, fields, or trials identified within the fields, may be compared to one another, based on the metric, to determine a potential confidence as to the designed, specific difference's contribution to deviation in performance between the test and control regions.

In the example embodiment of FIG. 1, therefore, the agricultural computer system 114 is configured to identify trials in the field 102, generally, and in some example embodiments, to also determine assessment metrics for the trials. It should be appreciated that the agricultural computer system 114 may be further configured to provide the identified trials, associated data, and/or the assessment metrics for one or more specific trials to the grower 104, for example, through a mobile application such as CLIMATE FIELDVIEW®, which is commercially available from Climate LLC, Saint Louis, Mo. as described herein.

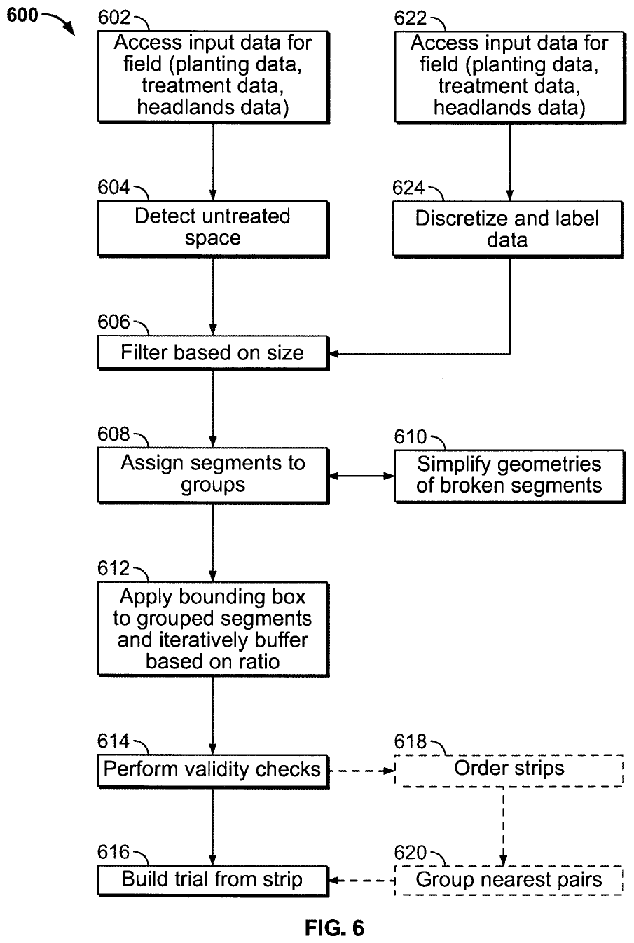

FIG. 6 illustrates an example method 600 for identifying a trial and/or assessing a trial in a target field. The example method 600 is described herein in connection with the system 100, and may be implemented, in whole or in part, in the agricultural computer system 114 of the system 100. However, it should be appreciated that the method 600, or other methods described herein, are not limited to the system 100 or the agricultural computer system 114. And, conversely, the systems, data servers, and the computing devices described herein are not limited to the example method 600.

At the outset in the method 600, it should be appreciated that data is stored in the data server 110 for the field 102, where the data is indicative of the features of the field 102 and prior use of the field 102 for planting, growing and harvesting of crops.

Initially in method 600, in a first implementation, the agricultural computer system 114 accesses, at 602, input data from the data server 110, for example. The input data may include, for example, planting data for the field 102 (i.e., a target field in this example), treatment data for the field 102, and headland data for the field 102, etc. The planting data and treatment data, as well as the headland data, are defined by location in the field 102, whereby each is associated with a coordinate and/or positioning in the field 102. It should be appreciated that in various embodiments the input data may be different depending on a type of the trial as know, or suspected, to be included in the field 102, or other fields, etc.

At 604, the agricultural computer system 114 detects, or identifies, in this example, the untreated segments (or space or part of the field 102) in the field 102 (e.g., the planted and untreated segments, etc.) (broadly, one or more segments having at least one feature distinct from a remainder of the field 102, etc.). In particular, in this embodiment, the agricultural computer system 114 overlays the treatment data for the field 102 (i.e., the target field) on the planting data for the field 102 to identify region(s) that are planted but untreated. The headlands are then eliminated or removed (based on the headland data), thereby leaving the untreated planted regions, which are not part of the headlands. It should be appreciated that input data may be combined in a variety of different manners, or orders, in order to detect the untreated segments or regions in the field 102. It should be further appreciated that in one or more embodiments, the method 600 may include detecting treated spaces or regions, rather than untreated segments or regions, in the field 102. In at least one embodiment, the headlands may not be removed, for example, where no specific defined headlands are available for the field 102, etc.

The agricultural computer system 114 then filters, at 606, the untreated segments for size (e.g., as defined by a geometric threshold, etc.), and in particular, in this example embodiment, width, whereby untreated segments that fail to satisfy the geometric threshold (or, alternatively, satisfy the threshold) are removed. Generally, a trial is understood to includes a specific, or minimum width, potentially associated with the width of a planter, or sprayer, etc., whereby a region having a width below a certain threshold is generally not a strip of a trial. The geometric threshold may be about ten meters, about twenty meters, about thirty meters, about sixty meters, or more or less, etc., depending on, for example, field dimensions, trial definitions, treatment types, farm equipment, or other suitable variables in the trial, etc. As such, the filtering, at 606, may remove or eliminate one or more segments from the untreated segments detected at 604 (e.g., that is/are smaller than the threshold, that is/are larger than the threshold, etc.).

In this example embodiment, the method 600 is based on the untreated segments of the field 102, as the example target field. As such, following the filtering operation, the agricultural computer system 114 identifies the remaining segments as control segments and identifies closest (or nearest) ones of the control segments into a set. In particular in the method 600, the agricultural computer system 114 assigns the segments from the field 102 to one or more groups, at 608.

In particular in the method 600, the agricultural computer system 114 assigns the segments from the field 102 to one or more groups, at 608. Each of the segments, as explained above, covers a region of the field 102, and each has a center. The agricultural computer system 114 determines a centroid of each of the segments, in this embodiment, and groups the segments based on the centroid. For example, where three segments each have a centroid which includes generally the same Y coordinate, in the X-Y coordinate system, the segments align. And then, when the planting direction in the field 102 is consistent with the Y axis, the agricultural computer system 114 may assign the three segment to the same group, as likely part of the same pass or passes by the planter. It should be appreciated that other techniques may be employed to group the segments, where necessary, as part of a same strip of a trial.

In connection with the above, for control segments that are broken or have interrupted shapes (e.g., based on headlands, etc.), the agricultural computer system 114 applies an iterative shape buffer to the segments first and then assigns the segments to the one or more groups (at 608). In doing so, for instance, in the example method 600, the agricultural computer system 114 smooths and/or simplifies geometries of the segments, at 610. More specifically, the untreated segments are defined by coordinates in the field 102, where outer boundaries of the segments are thus also defined by coordinates in the field. By smoothing, or simplifying the geometrics of the broken or interrupted segments, the agricultural computer system 114 reduces the number of coordinates used to define the geometry of each of the segments. One example function used, by the agricultural computer system 114, may be the simplify function, as understood by those skilled in the art, where a threshold of one meter, two meters, or more or less, may be set to permit the function to smooth or simplify the geometry.

It should be appreciated that in one or more embodiments, smoothing or simplifying the geometrics of the segments may be omitted.

Next in the method 600, the agricultural computer system 114 applies, at 612, a bounding box to the segment, or grouped segments. The bounding box, generally, is a rectangle, which fully encloses the segment, or group of segments (e.g., a minimum bounding box, etc.). The agricultural computer system 114 determines a ratio, in this example embodiment, between the area of the segment(s) and the area of the bounding box and compares the ratio to a threshold (e.g., a ratio of 50%, 60%, 70%, or more or less, etc.). In response to the ratio, and based on the ratio not satisfying the threshold, the agricultural computer system 114 buffers (at 612) the segment(s), by applying a size buffer (e.g., a one meter, two meter, or more or less, buffer, etc.) to the segments, whereby the geometry of the segment(s) is reduced or shrunk by the buffer (e.g., one meter, two meters, etc.). Next, the agricultural computer system 114 again applies a bounding box to the segment(s) and again determines a ratio of the area of the segments to the area of the bounding box. Again, when the ratio fails to satisfy the threshold, the agricultural computer system 114 repeats the above. In this manner, the agricultural computer system 114 iteratively applies the buffer (at 612) to the segment or group of segments whereby the agricultural computer system 114 continues to shrink, reduce or buffer the segment or groups of segment by the buffer value (until the ratio threshold is satisfied or until a minimum total buffer size is reached). When the ratio threshold is satisfied, the agricultural computer system 114 proceeds in the method 600. However, if the ratio threshold is not satisfied, and the final reduced buffer size (or reduced threshold size) is exhausted (e.g., fifteen meters (total), etc.), the method 600 ends, and no trial is detected and/or identified.

With that said, it should be appreciated that the operations described above at 608, 610, and 612 may be performed in other orders, or at similar times, within the scope of the present disclosure. For instance, in some example embodiments, the agricultural computer system 114 may assign segments to groups (at 608), applying a bounding box to grouped segments and iteratively buffer the grouped segments (at 612) and then simplify geometries of certain segments (at 610).

With continued reference to FIG. 6, when the ratio threshold is satisfied, though, the agricultural computer system 114 performs, at 614, one or more validity checks for the segment or group of segments. The validity checks may include, without limitation, a threshold size (e.g., does the segment or group of segments have at least a minimum length, width, area, perimeter, or combination thereof, etc.), a shape profile (e.g., does the segment or group of segments define a strip or have dimensions that define a particular ratio or define a ratio within a particular range, etc.), etc.

When the segment or group of segments pass the one or more of the validity checks (or each of the validity checks), the agricultural computer system 114 identifies the segment or the groups of segments as a strip (e.g., an area having a length longer than its width, yet contained in the target field, etc.) and then builds (e.g., compiles, assembles, etc.), at 616, the trial from the strip. In this example, the method 600 is based on the untreated segments of the field 102, whereby the strip identified is a control strip. As such, for a triplet trial, in order to build the trial, the agricultural computer system 114 duplicates the strip on either long side of the identified control strip (as test strips) (yet within the boundary/headlands of the field and/or taking into account (or subject to) the boundary and/or headlands) to define the trial triplet. The duplicate strip or strip(s) may include one or more of the same geometries on the control strip (e.g., width, etc.), yet bounded by the boundary/headlands, etc., of the filed 102. It should be appreciated that the test strips built onto either long edge of the identified control strip are generally the same size as the identified control strip in this example, but may be otherwise in other embodiments.

In this example embodiment, the agricultural computer system 114 stores the trial, as defined by size, and specifically, by location, in a memory, whereby it may be used to separate data, instruct data processing, etc., and/or whereby it may be displayed to grower 104 and/or other users, alone or in connection with data associated with the field 102, etc.

In the above example, the trial is built (at 616) based on a test-control-test triplet definition. In other instances, the trial may be built based on a control-test-control definition, whereby the identified strip is one of two control strips in the trial. Here, at 618, optionally or alternatively (as indicated by the dotted lines), the agricultural computer system 114 orders the segments (or groups of segments) to account for the control-test-control triplet definition. For example, the agricultural computer system 114 may determine a centroid of each of the segments and then order the centroids (e.g., based on X-Y coordinates, etc.), and then group, at 620, the closest pairs of identified strips. The agricultural computer system 114 then determines whether the closest pairs are within a threshold distance of one another. If so, the pairs of identified strips proceed to step 616, where the agricultural computer system 114 builds a trial by including a test strip between the pair of identified control strips. If the closest pairs are not within the threshold distance, the identified strips go in separately to step 616, where potentially two trials are built as described above.

In addition to the above, it should be appreciated that the agricultural computer system 114 may further apply one or more buffers to the trials (in various sizes) to inhibit data crossover for certain types of trials (as generally described above in the system 100). For example, where the treatment is applied aerially, the buffer is applied as the treatment may be wider than for a treatment applied by a ground sprayer.

It should be appreciated that the data associated with the buffering, shrinking and/or smoothing in the method 600 may be retained and/or associated with the trial to prevent data associated with a control strip, for example, to be attributed with the test strips. For instance, as described above in the system 100, FIGS. 3B-3C illustrates a protrusion of the control strip, which extends left, which generally falls in the initial bounding of the test strip, as defined above. As such, the agricultural computer system 114 may maintain a knowledge thereof to ensure data from the untreated segment 304 (having the protrusion), as originally detected based on location, is not attributed to an adjacent test strip (where the control strip in FIGS. 3B-3C is part of a test-control-test triplet definition).

With continued reference to FIG. 6, in another implementation of the method 600, continuous input data from the data server 110 may also (or alternatively) be accessed, at 622, by the agricultural computer system 114 in connection with determining a trial in the field 102 (e.g., in addition to the data accessed at 602, instead of the data accessed at 602, etc.). Here, the accessed input data is continuous data, rather than discrete data (as accessed at 602). For example, the input data may indicate a planting rate, as continuous, in comparison to treatment data (i.e., treated or not-treated). After accessing the data, the agricultural computer system 114 discretizes, at 624, the data into bands defined by specific ranges of the data. For example, the range of data may be divided into numerous bands, from a lower value to a higher value sufficient to assign each data value per location in the field 102 to a band corresponding to a specific range. As explained above, FIG. 4 illustrates an example of planting rate data assigned to the different ranges. In this manner, the continuous data is represented as discrete data, as assigned to the different ranges.

Next in in this implementation of the method 600, the agricultural computer system 114 labels the data (at 624), based on the data being assigned to the different bands. For example, the data may be clustered or segmented into a number of groups, such as, for example, two groups, three groups, four groups, more than four groups, etc. In this example, the field 102 is planted at two different rates, a conventional rate and a test rate. The data, when discretized in this example, forms peaks at the two different planting rates. The agricultural computer system 114 may then employ a Gaussian model to cluster the bands of data into the desired number of groups/components (e.g., two, etc.), based on the data assigned to the band. The labels, in turn, are assigned, by the agricultural computer system 114, whereby a first label will correspond to a first condition (or condition one) in the field 102 and a second label will correspond to a second condition (or condition two) in the field 102, i.e., one being the test and the other being the control, in this example embodiment.

The agricultural computer system 114 then proceeds to filtering the data associated with one of the labels (e.g., the control segment or the test segment, etc.), at 606 (in generally the same manner as described above) and proceeds with the method 600 through operations 608-620 as generally described above.

Upon identifying the trial(s) in the field 102, via the method 600, the agricultural computer system 114 may then determine, compile, generate, etc. on or more metrics for the trial(s), for example, based on a comparison of the trial(s) in the field 102 (e.g., taking into account yield or other factors of the field/trial(s), etc.) to one or more other parts of the field 102 or to one or more other fields.

With reference again to FIG. 1, the grower 104 in the system 100 may own, operate or possess a field manager computing device 116 in a field location, or associated with a field location, such as field 102, intended for agricultural activities or a management location for one or more agricultural fields. The field manager computing device 116 is programmed, or configured, to provide field data to the agricultural computer system 114 via one or more networks (as indicated by arrowed lines in FIG. 1) (e.g., for use in identifying characteristics of target field 102, for use in identifying trials in the field 102, etc.). The field manager computing device 116 is also programmed, or configured, to receive data from the agricultural computer system 114, for example, the identified trial(s) described above, the metric(s) relating to the identified trial(s), etc. The network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data are provided above in connection with the description of the system 100. Additional examples may include, without limitation, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (1) other data described herein, etc.

As described, data server 110 is communicatively coupled to the agricultural computer system 114 and is programmed, or configured, to send external data (e.g., data associated with fields, etc.) to and/or receive other data from (e.g., identification of trials, generated metrics, etc.) agricultural computer system 114 via the network(s) herein (e.g., for use in identifying candidate seeds, treatments, etc. for the target field 102 identified by the grower 104; for use in modified such selections and/or identifications of seeds, treatments, etc.; etc.). The data server 110 may be owned or operated by the same legal person or entity as the agricultural computer system 114, or by a different person or entity, such as a government agency, non-governmental organization (NGO), and/or a private data service provider. Examples of external data include weather data, imagery data, soil data, seed data and seed selection data as described herein, data from the field 102, or statistical data relating to crop yields, among others. External data may include the same type of information as field data. In some embodiments, the external data may also be provided by data server 110 owned by the same entity that owns and/or operates the agricultural computer system 114. For example, the agricultural computer system 114 may include a data server focused exclusively on a type of data that might otherwise be obtained from third party sources, such as weather data. In some embodiments, data server 110 may actually be incorporated within the system 114.

The system 100 also includes, as described above, farm equipment (e.g., planter 106, harvester 108, a sprayer, etc.) configured to plant and harvest seeds from one or more growing spaces (e.g., from field 102, etc.) and provide treatments thereto, etc. In some examples, the farm equipment may have one or more remote sensors fixed thereon, where the sensor(s) are communicatively coupled, either directly or indirectly, via the farm equipment to the agricultural computer system 114 and are programmed, or configured, to send sensor data to agricultural computer system 114.

Notwithstanding the above, examples of agricultural apparatus that may be utilized in the system 100 (and in the field 102) include tractors, combines, other harvesters, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the agricultural apparatus may comprise a plurality of sensors that are coupled locally in a network on the apparatus. Controller area network (CAN) is an example of such a network that can be installed in combines, harvesters, sprayers, and cultivators. In connection therewith, then, an application controller associated with the apparatus may be communicatively coupled to agricultural computer system 114 via the network(s) and programmed, or configured, to receive one or more scripts that are used to control an operating parameter of the agricultural apparatus (or another agricultural vehicle or implement) from the agricultural computer system 114. For instance, a CAN bus interface may be used to enable communications from the agricultural computer system 114 to the agricultural apparatus, for example, such as how the CLIMATE FIELDVIEW® DRIVE, available from Climate LLC, Saint Louis, Mo., is used. Sensor data may consist of the same type of information as field data. In some embodiments, remote sensors may not be fixed to an agricultural apparatus but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the farm equipment in the system 100, data server 110, agricultural computer system 114, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Agricultural computer system 114 is programmed, or configured, to receive field data from field manager computing device 116, external data from data server 110, and sensor data from one or more remote sensors in the system 100, and also to provide data to the field manager computing device 116. Agricultural computer system 114 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, as shown in FIG. 1, for example, agricultural computer system 114 is programmed with or comprises a communication layer 118, a presentation layer 120, a data management layer 124, a hardware/virtualization layer 126, and a model and field data repository 128. “Layer,” in this context, refers to any combination of electronic digital interface circuits, microcontrollers, firmware, such as drivers, and/or computer programs, or other software elements.

Communication layer 118 may be programmed, or configured, to perform input/output interfacing functions including sending requests to field manager computing device 116, data server 110, and remote sensor(s) for field data, external data, and sensor data respectively. Communication layer 118 may be programmed, or configured, to send the received data to repository layer 128 to be stored as field data (e.g., in computer system 114, etc.).

Presentation layer 120 may be programmed, or configured, to generate a graphical user interface (GUI) to be displayed on field manager computing device 116 (e.g., for use in interacting with agricultural computer system 114 to identify the target field 102, target seed, etc.) or other computers that are coupled to the system 114 through the network(s). The GUI may comprise controls for inputting data to be sent to agricultural computer system 114, generating requests for models and/or recommendations, and/or displaying recommendations, notifications, models, and other field data.

Data management layer 124 may be programmed, or configured, to manage read operations and write operations involving the repository layer 128 and other functional elements of the system, including queries and result sets communicated between the functional elements of the system and the repository. Examples of data management layer 124 include JDBC, SQL server interface code, and/or HADOOP interface code, among others. Repository layer 128 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data is not provided directly to the agricultural computer system 114 via one or more agricultural machines or agricultural machine devices that interact with the agricultural computer system 114, the grower 104 may be prompted via one or more user interfaces on the device 116 (served by the agricultural computer system 114) to input such information for use in effecting the selections herein. In an example embodiment, the grower 104 may specify identification data by accessing a map on the device 116 (served by the agricultural computer system 114) and selecting specific CLUs that have been graphically shown on the map. In an alternative embodiment, the grower 104 may specify identification data by accessing a map on the device 116 (served by the agricultural computer system 114) and drawing boundaries of the field over the map. Such CLU selection, or map drawings, represent geographic identifiers. In alternative embodiments, the grower 104 may specify identification data by accessing field identification data (provided as shape files or in a similar format) from the U.S. Department of Agriculture Farm Service Agency, or other source, via the device 116 and providing such field identification data to the agricultural computer system 114.

In an example embodiment, the agricultural computer system 114 is programmed to generate and cause displaying of a graphical user interface comprising a data manager for data input. After one or more fields (and/or trials) have been identified using the methods described above, the data manager may provide one or more graphical user interface widgets which when selected can identify changes to the field, soil, crops, tillage, nutrient practices, and/or which may provide comparison data related to target seed identified by the grower 104 and candidate seeds identified by the disclosure herein for the target field 102. The data manager may include a timeline view, a spreadsheet view, a graphical view, and/or one or more editable programs.

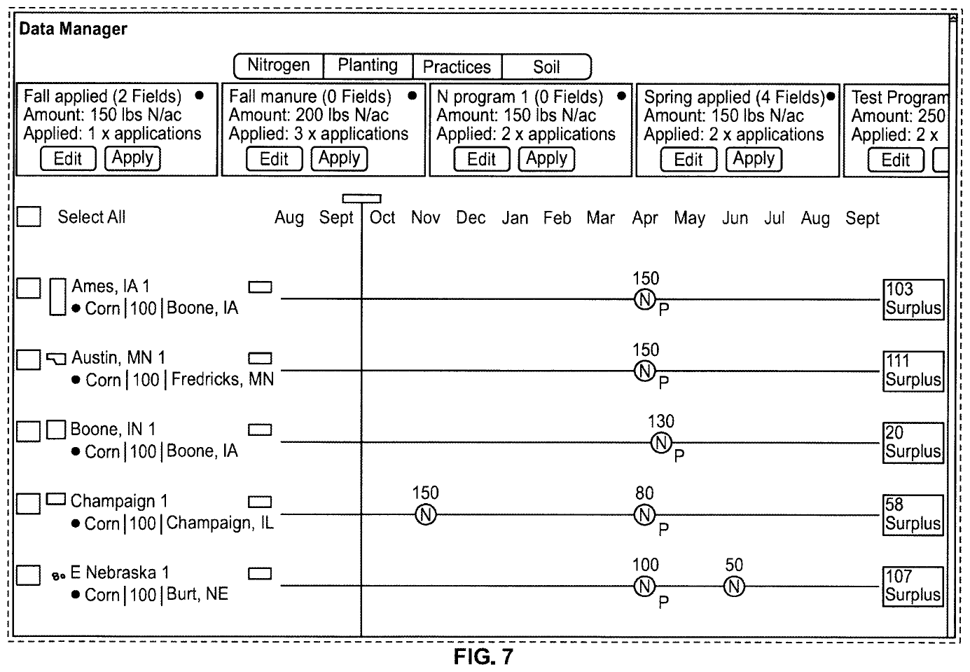

FIG. 7 depicts an example embodiment of a timeline view for data entry. Using the display depicted in FIG. 7, a user computer can input a selection of a particular field and a particular date for the addition of events (e.g., treatments, etc.). Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager 124 provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 7, the top two timelines have the “Spring applied” program selected, which includes an application of 150 lbs N/ac in early April. The data manager may provide an interface for editing a program. In an embodiment, when a particular program is edited, each field that has selected the particular program is edited. For example, in FIG. 7, if the “Spring applied” program is edited to reduce the application of nitrogen to 116 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the field in FIG. 7, the interface may update to indicate that the “Spring applied” program is no longer being applied to the top field. While the nitrogen application in early April may remain, updates to the “Spring applied” program would not alter the April application of nitrogen.

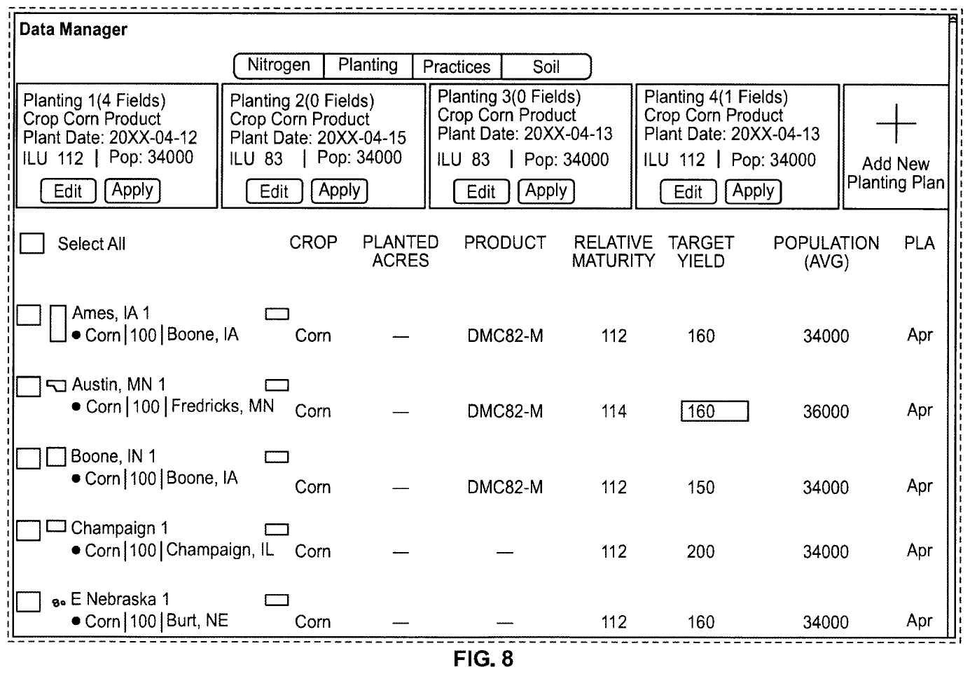

FIG. 8 depicts an example embodiment of a spreadsheet view for data entry. Using the display depicted in FIG. 8, a user can create and edit information for one or more fields. The data manager may include spreadsheets for inputting information with respect to Nitrogen, Planting, Practices, and Soil as depicted in FIG. 8. To edit a particular entry, a user computer may select the particular entry in the spreadsheet and update the values. For example, FIG. 8 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in data repository layer 128. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

With reference again to FIG. 1, in an embodiment, instructions 122 of the agricultural computer system 114 may comprise a set of one or more pages of main memory, such as RAM, in the agricultural computer system 114 into which executable instructions have been loaded and which when executed cause the agricultural computer system 114 to perform the functions or operations that are described herein. For example, the instructions 122 may comprise a set of pages in RAM that contain instructions which, when executed, cause performing the seed identification functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 122 also may represent one or more files or projects of source code that are digitally stored in a mass storage device, such as non-volatile RAM or disk storage, in the agricultural computer system 114 or a separate repository system, which when compiled or interpreted cause generating executable instructions which when executed cause the agricultural computer system 114 to perform the functions or operations that are described herein. In other words, the drawing figure may represent the manner in which programmers or software developers organize and arrange source code for later compilation into an executable, or interpretation into bytecode or the equivalent, for execution by the agricultural computer system 114.

Hardware/virtualization layer 126 comprises one or more central processing units (CPUs), memory controllers, and other devices, components, or elements of a computer system, such as volatile or non-volatile memory, non-volatile storage, such as disk, and I/O devices or interfaces as illustrated and described herein. The layer 126 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 116 associated with different users. Further, the system 114 and/or data server 110 may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, grower 104 interacts with agricultural computer system 114 using field manager computing device 116 configured with an operating system and one or more application programs or apps; the field manager computing device 116 also may interoperate with the agricultural computer system 114 independently and automatically under program control or logical control and direct user interaction is not always required. Field manager computing device 116 broadly represents one or more of a smart phone, PDA, tablet computing device, laptop computer, desktop computer, workstation, or any other computing device capable of transmitting and receiving information and performing the functions described herein. Field manager computing device 116 may communicate via a network using a mobile application stored on field manager computing device 116, and in some embodiments, the device may be coupled using a cable or connector to one or more sensors and/or other apparatus in the system 100. A particular grower 104 may own, operate or possess and use, in connection with system 100, more than one field manager computing device 116 at a time.

The mobile application associated with the field manager computing device 116 may provide client-side functionality, via the network to one or more mobile computing devices. In an example embodiment, field manager computing device 116 may access the mobile application via a web browser or a local client application or app. Field manager computing device 116 may transmit data to, and receive data from, one or more front-end servers, using web-based protocols, or formats, such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 116 which determines the location of field manager computing device 116 using standard tracking techniques, such as multilateration of radio signals, the global positioning system (GPS), WiFi positioning systems, or other methods of mobile positioning. In some cases, location data or other data associated with the device 116, grower 104, and/or user account(s) may be obtained by queries to an operating system of the device or by requesting an app on the device to obtain data from the operating system.

In an embodiment, in addition to other functionalities described herein, field manager computing device 116 sends field data (or other data) to agricultural computer system 114 comprising or including, but not limited to, data values representing one or more of: a geographical location of the one or more fields, tillage information for the one or more fields, crops planted in the one or more fields, and soil data extracted from the one or more fields. Field manager computing device 116 may send field data in response to user input from grower 104 specifying the data values for the one or more fields. Additionally, field manager computing device 116 may automatically send field data when one or more of the data values becomes available to field manager computing device 116. For example, field manager computing device 116 may be communicatively coupled to a remote sensor in the system 100, and in response to an input received at the sensor, field manager computing device 116 may send field data to agricultural computer system 114 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the field manager computing device 116 may also be stored as external data (e.g., where the field data is collected as part of harvesting crops from the field 102, etc.), for example, in data server 110.

A commercial example of the mobile application is CLIMATE FIELDVIEW®, commercially available from Climate LLC, Saint Louis, Mo. The CLIMATE FIELDVIEW® application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

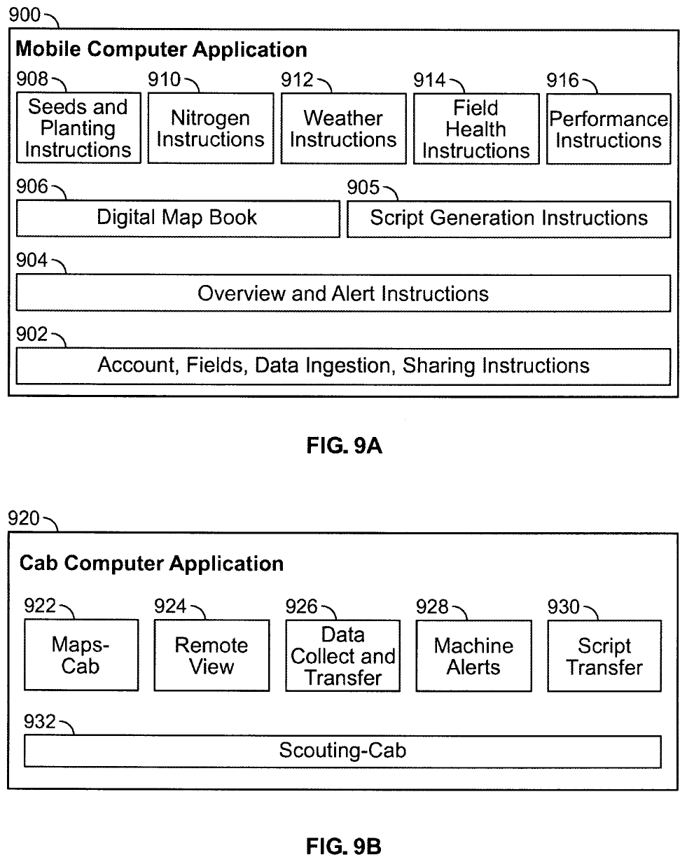

FIGS. 9A-9B illustrate two views of an example logical organization of sets of instructions in main memory when an example mobile application is loaded for execution. Each named element represents a region of one or more pages of RAM or other main memory, or one or more blocks of disk storage or other non-volatile storage, and the programmed instructions within those regions. In one embodiment, in FIG. 9A, a mobile computer application 900 comprises account-fields-data ingestion-sharing instructions 902, overview and alert instructions 904, digital map book instructions 906, seeds and planting instructions 908, nitrogen instructions 910, weather instructions 912, field health instructions 914, and performance instructions 916.

In one embodiment, a mobile computer application 900 comprises account, fields, data ingestion, sharing instructions 902 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 900 comprises a data inbox. In response to receiving a selection of the data inbox, the mobile computer application 900 may display a graphical user interface for manually uploading data files and importing uploaded files to a data manager.

In one embodiment, digital map book instructions 906 comprise field map data layers stored in device memory and are programmed with data visualization tools and geospatial field notes. This provides growers with convenient information close at hand for reference, logging and visual insights into field performance. In one embodiment, overview and alert instructions 904 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 908 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 905 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 900 may display one or more fields broken into management zones, such as the field map data layers created as part of digital map book instructions 906. In one embodiment, the management zones comprise soil zones along with a panel identifying each soil zone and a soil name, texture, drainage for each zone, or other field data. Mobile computer application 900 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 900 may make the script available for download in a format readable by an application controller, such as an archived or compressed format. Additionally, and/or alternatively, a script may be sent directly to a cab computer (e.g., associated with planter 106, harvester 108, etc.) from mobile computer application 900 and/or uploaded to one or more data servers and stored for further use.

In one embodiment, nitrogen instructions 910 are programmed to provide tools to inform nitrogen decisions by visualizing the availability of nitrogen to crops. This enables growers to maximize yield or return on investment through optimized nitrogen application during the season. Example programmed functions include displaying images, such as SSURGO images, to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 900. For example, nitrogen instructions 910 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation, such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 910 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 910 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 910 could be used for application of other nutrients (such as phosphorus and potassium), application of pesticide, and irrigation programs.

In one embodiment, weather instructions 912 are programmed to provide field-specific recent weather data and forecasted weather information. This enables growers to save time and have an efficient integrated display with respect to daily operational decisions.

In one embodiment, field health instructions 914 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 916 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 916 may be programmed to communicate via the network(s) to back-end analytics programs executed at agricultural computer system 114 and/or data server 110 and configured to analyze metrics, such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of a cab computer (e.g., associated with planter 106, harvester 108, etc.). For example, referring now to FIG. 9B, in one embodiment a cab computer application 920 (e.g., as accessible in planter 106, harvester 108, etc., etc.) may comprise maps-cab instructions 922, remote view instructions 924, data collect and transfer instructions 926, machine alerts instructions 928, script transfer instructions 930, and scouting-cab instructions 932. The code base for the instructions of FIG. 9B may be the same as for FIG. 9A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 922 may be programmed to provide map views of fields, farms or regions that are useful in directing machine operation. The remote view instructions 924 may be programmed to turn on, manage, and provide views of machine activity in real-time or near real-time to other computing devices connected to the computer system 114 via wireless networks, wired connectors or adapters, and the like. The data collect and transfer instructions 926 may be programmed to turn on, manage, and provide transfer of data collected at sensors and controllers to the computer system 114 via wireless networks, wired connectors or adapters, and the like (e.g., via network(s) in the system 100, etc.). The machine alerts instructions 928 may be programmed to detect issues with operations of the machine or tools that are associated with the cab and generate operator alerts. The script transfer instructions 930 may be configured to transfer in scripts of instructions that are configured to direct machine operations or the collection of data. The scouting-cab instructions 932 may be programmed to display location-based alerts and information received from the computer system 114 based on the location of the field manager computing device 116, farm equipment, or sensors in the field 102 and ingest, manage, and provide transfer of location-based scouting observations to the computer system 114 based on the location of the farm equipment or sensors in the field 102.

In an embodiment, data server 110 stores external data, including soil data representing soil composition for the one or more fields and weather data representing temperature and precipitation on the one or more fields. The weather data may include past and present weather data as well as forecasts for future weather data. In an embodiment, data server 110 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil. Further, in some embodiments, the data server 110, again, may include data associated with the field 102 with regard to available seeds for use in comparisons, etc.

In an embodiment, remote sensors in the system 100 may comprises one or more sensors that are programmed, or configured, to produce one or more observations. Remote sensor may be aerial sensors, such as satellites, vehicle sensors, planting equipment sensors, tillage sensors, fertilizer or insecticide application sensors, harvester sensors, and any other implement capable of receiving data from the one or more fields (e.g., field 102, etc.). In an embodiment, farm equipment may include an application controller programmed, or configured, to receive instructions from agricultural computer system 114. The application controller may also be programmed, or configured, to control an operating parameter of the farm equipment. Other embodiments may use any combination of sensors and controllers, of which the following are merely selected examples.

The system 100 may obtain or ingest data under grower 104 control, on a mass basis from a large number of growers who have contributed data to a shared database system. This form of obtaining data may be termed “manual data ingest” as one or more user-controlled computer operations are requested, or triggered, to obtain data for use by the computer system 114. As an example, the CLIMATE FIELDVIEW® application, commercially available from Climate LLC, Saint Louis, Mo., may be operated to export data to computer system 114 for storing in the repository layer 128.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population and other information to the user via a cab computer of the apparatus, or other devices within the system 100. Examples are disclosed in U.S. Pat. No. 8,738,243 and US Pat. Pub. 20126094916, and the present disclosure assumes knowledge of those other patent disclosures.

Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosures.

In an embodiment, sensors and controllers may be affixed to soil sampling and measurement apparatus that is configured, or programmed, to sample soil and perform soil chemistry tests, soil moisture tests, and other tests pertaining to soil. For example, the apparatus disclosed in U.S. Pat. No. 8,767,194 and U.S. Pat. No. 8,712,148 may be used, and the present disclosure assumes knowledge of those patent disclosures.

In an embodiment, sensors and controllers may comprise weather devices for monitoring weather conditions of fields. For example, the apparatus disclosed in published international application WO2016/176355A1, may be used, and the present disclosure assumes knowledge of that patent disclosure.

In an embodiment, the agricultural computer system 114 is programmed, or configured, to create an agronomic model. In this context, an agronomic model is a data structure in memory of the agricultural computer system 114 that comprises field data, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors, such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples, the revenue or profit obtained from the produced crop.

In an embodiment, the agricultural computer system 114 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

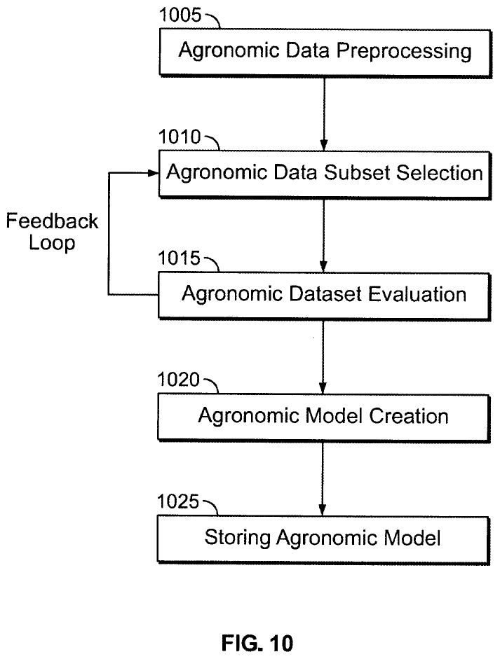

FIG. 10 illustrates a programmed process by which the agricultural computer system 114 generates one or more preconfigured agronomic models using field data provided by one or more data sources. FIG. 10 may serve as an algorithm or instructions for programming the functional elements of the agricultural computer system 114 to perform the operations that are now described.

At block 1005, the agricultural computer system 114 is configured, or programmed, to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 1010, the agricultural computer system 114 is configured, or programmed, to perform data subset selection using the preprocessed field data in order to identify datasets useful for initial agronomic model generation. The agricultural computer system 114 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 1015, the agricultural computer system 114 is configured, or programmed, to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 1010).

At block 1020, the agricultural computer system 114 is configured, or programmed, to implement agronomic model creation based upon the cross validated agronomic datasets. In an embodiment, agronomic model creation may implement multivariate regression techniques to create preconfigured agronomic data models.

At block 1025, the agricultural computer system 114 is configured, or programmed, to store the preconfigured agronomic data models for future field data evaluation.

According to one embodiment, the techniques described herein are implemented by one or more special-purpose computing devices. The special-purpose computing devices may be hard-wired to perform the techniques, or may include digital electronic devices, such as one or more application-specific integrated circuits (ASICs) or field programmable gate arrays (FPGAs), that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

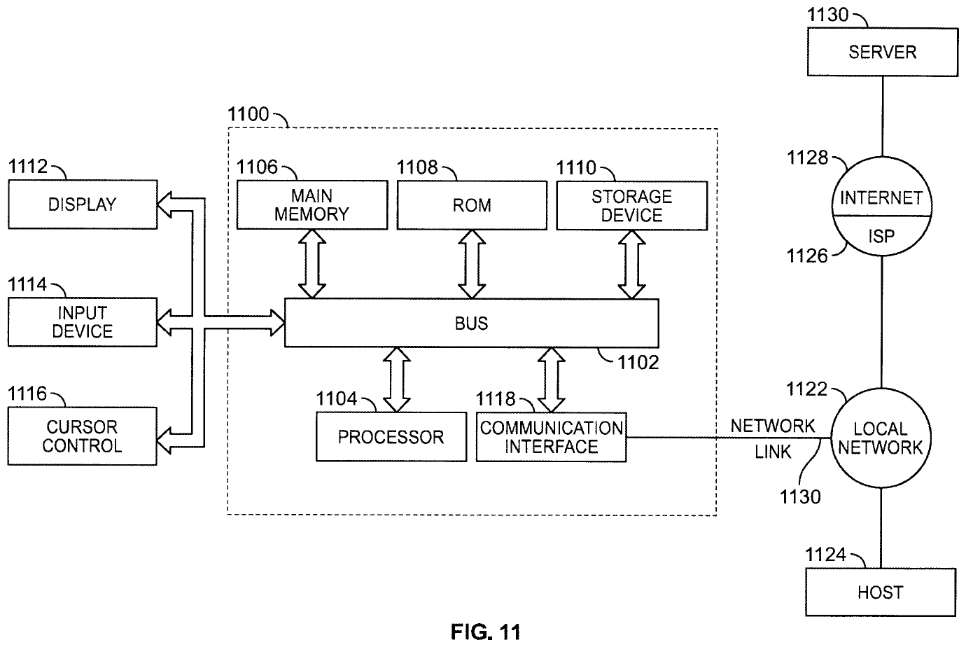

For example, FIG. 11 is a block diagram that illustrates a computer system 1100 upon which embodiments of the present disclosure may be implemented. Computer system 1100 includes a bus 1102 or other communication mechanism for communicating information, and a hardware processor 1104 coupled with bus 1102 for processing information. Hardware processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108, or other static storage device coupled to bus 1102, for storing static information and instructions for processor 1104. A storage device 1110, such as a magnetic disk, optical disk, or solid-state drive, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x, etc.) and a second axis (e.g., y, etc.), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 1110. Volatile media includes dynamic memory, such as main memory 1106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infrared data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infrared signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing, for a target field, planting data for the target field from a data structure; (b) identifying one or multiple segment(s) of the target field having at least one feature distinct from a remainder of the field; (c) applying a first geometric threshold to the identified segment(s); and (d) in response to the identified segment(s) satisfying the first geometric threshold: (i) validating, by the computing device, at least one strip including the segment(s), based on a length and width of the at least one strip; and (ii) building, by the computing device, a trial based on the at least one strip, wherein the trial includes the at least one strip and at least one duplicate strip disposed along a long side of the at least one strip, the trial identified as a location of the trial in the target field.

As will also be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing, for a target field, planting data for the target field from a data structure; (b) identifying one or multiple segment(s) of the target field having at least one feature distinct from a remainder of the field; (c) applying a first geometric threshold to the identified segment(s); and (d) in response to the identified segment(s) satisfying the first geometric threshold: (i) simplifying a geometry of each of the segment(s); (ii) grouping the segment(s) into a strip; (iii) validating the strip based on a second geometric threshold; and (iv) in response to the strip being validated, building a trial based on the strip, wherein the trial includes the strip and at least one duplicate strip disposed along a long side of the strip, the trial identified as a location of the trial in the target field.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying a trial in a target field, the method comprising:
accessing, by a computing device, for a target field, planting data for the target field from a data structure;
identifying, by the computing device, one or multiple segment(s) of the target field having at least one feature distinct from a remainder of the field;
applying, by the computing device, a first geometric threshold to the identified segment(s); and
in response to the identified segment(s) satisfying the first geometric threshold:
validating, by the computing device, at least one strip including the segment(s), based on a length and width of the at least one strip; and
building, by the computing device, a trial based on the at least one strip, wherein the trial includes the at least one strip and at least one duplicate strip disposed along a long side of the at least one strip, the trial identified as a location of the trial in the target field.

2. The method of claim 1, wherein applying the first geometric threshold includes applying a minimum width to the each of the identified segments.

3. The method of claim 1, wherein applying the first geometric threshold includes, for each identified segment:
generating a bounding box around the identified segment; and
imposing the first geometric threshold on a ratio of an area of said identified segment relative to an area of the bounding box.

4. The method of claim 1, further comprises accessing, by a computing device, treatment data for the target field;
wherein the at least one feature includes a presence or absence of a treatment indicated in the treatment data; and
wherein identifying the segments of the target field having the at least one feature includes:
overlaying the treatment data and the planting data for the target field; and
selecting ones of the segments which are planted and have the at least one feature.

5. The method of claim 1, further comprising grouping ones of the identified segment(s) into the at least one strip; and
wherein applying the first geometric threshold to the identified segment(s) includes applying the first geometric threshold to the at least one strip.

6. The method of claim 1, wherein the at least on feature includes a seeding rate; and
wherein identifying the segment(s) of the field having the at least one feature includes:
grouping each of the segment(s) of the target field into one of multiple bands of planting rates of seeds;
aggregating the segment(s) within each of the multiple groups of the plant rates of seeds; and
selecting the segment(s) of the target field grouped into at least one of the bands having a highest number of aggregated segments therein.

7. The method of claim 1, further comprising simplifying a geometry of the segment(s) prior to validating the at least one strip including the segment(s).

8. The method of claim 1, further comprising, in response to the identified segment(s) satisfying the first geometric threshold:
grouping ones of the segment(s) into the at least one strip based on: coordinates associated with a centroid of each of the identified segments and a grouping threshold associated with the coordinates of the centroids, prior to validating the at least one strip.

9. The method of claim 1, further comprising, in response to the identified segment(s) satisfying the first geometric threshold:
generating, by the computing device, a bounding box around the at least one strip;
determining, by the computing device, a ratio of an area of the segment(s) and an area of the bounding box; and
trimming, by the computing device, the segment(s), in response to the ratio failing to satisfy a second geometric threshold.

10. The method of claim 1, wherein the at least one feature includes an absence of a treatment; and
wherein the at least one duplicate strip disposed along the long side of the at least one strip includes two duplicate strips disposed along each opposite long side of the at least one strip, wherein the duplicate strips are subject to one or more boundaries and/he headlands of the target field.

11. The method of claim 1, further comprising labeling, by the computing device, data included in the data structure, based on the data being associated with the trial and/or a location in the target filed defined by the trial.

12. A system for use in identifying a trial in a target field, the system comprising an agricultural computer system, which is configured, by executable instructions, to:
access, for a target field, planting data for the target field from a data structure;
identify one or multiple segment(s) of the target field having at least one feature distinct from a remainder of the field;
apply a first geometric threshold to the identified segment(s); and
in response to the identified segment(s) satisfying the first geometric threshold:
simplify a geometry of each of the segment(s);
group the segment(s) into a strip;
validate the strip based on a second geometric threshold; and
in response to the strip being validated, build a trial based on the strip, wherein the trial includes the strip and at least one duplicate strip disposed along a long side of the strip, the trial identified as a location of the trial in the target field.

13. The system of claim 12, wherein the agricultural computer system is further configured, by the executable instructions, to, after grouping the segment(s) into the strip:
i) generate a bounding box around the strip;
ii) determine a ratio of an area of the segment(s) and an area of the bounding box;
iii) trim the segment(s), in response to the ratio failing to satisfy a third geometric threshold; and
repeat operations i) — iii) until the ratio satisfies the third geometric threshold.

14. The system of claim 12, wherein the trial includes a trial triplet including the strip and two duplicate strips; and/or
wherein the at least one duplicate strip is a duplicate of the strip in size and shape; and/or
wherein the agricultural computer system is further configured, by the executable instructions, to label data included in the data structure, based on the data being associated with the trial and/or a location in the target field defined by the trial.

15. A non-transitory computer-readable storage medium comprising executable instructions for identifying trials in a target field, which when executed by at least one processor, cause the at least one processor to:
access, for a target field, planting data for the target field from a data structure;
identify one or multiple segment(s) of the target field having at least one feature distinct from a remainder of the field;
apply a first geometric threshold to the identified segment(s); and
in response to the identified segment(s) satisfying the first geometric threshold:
validate at least one strip including the segment(s), based on a length and width of the at least one strip; and
build a trial in the target field based on the at least one strip, wherein the trial includes the at least one strip and at least one duplicate strip disposed along a long side of the at least one strip, the trial identified as a location of the trial in the target field.

16. The non-transitory computer-readable storage medium of claim 15, wherein the executable instructions, when executed by the at least one processor, cause the at least one processor, in applying the first geometric threshold includes, for each identified segment, to:
generate a bounding box around the identified segment; and
impose the first geometric threshold on a ratio of an area of said identified segment relative to an area of the bounding box.

17. The non-transitory computer-readable storage medium of claim 15, wherein the at least one feature includes a presence or absence of a treatment indicated in the treatment data;
and wherein the executable instructions, when executed by the at least one processor, cause the at least one processor, in identifying the segments of the target field having the at least one feature, to:
overlay the treatment data and the planting data for the target field; and
select ones of the segments which are planted and have the at least one feature.

18. The non-transitory computer-readable storage medium of claim 15, wherein the executable instructions, when executed by the at least one processor, cause the at least one processor, in response to the identified segment(s) satisfying the first geometric threshold, to:
generate a bounding box around the at least one strip;
determine a ratio of an area of the segment(s) and an area of the bounding box; and
trim the segment(s), in response to the ratio failing to satisfy a second geometric threshold.

19. The non-transitory computer-readable storage medium of claim 15, wherein the at least one feature includes an absence of a treatment; and
wherein the at least one duplicate strip disposed along the long side of the at least one strip includes two duplicate strips disposed along each opposite long side of the at least one strip, yet contained within a boundary of the field.
